(19) United States
(12) Patent Application Publication
(10) Pub. No.: US 2018/0250935 A1
(43) Pub. Date: Sep. 6, 2018

(54) ELECTRONIC DEVICE

(71) Applicant: Seiko Epson Corporation, Tokyo (JP)

(72) Inventors: Shuichi Tanaka, Chino (JP); Naoya Sato, Sakata (JP); Tsuyoshi Yoda, Matsumoto (JP); Toshinari Nanba, Sakata (JP)

(21) Appl. No.: 15/551,801

(22) PCT Filed: Jan. 26, 2016
(86) PCT No.: PCT/JP2016/000382

§ 371 Date: Aug. 17, 2017

(30) Foreign Application Priority Data
Feb. 27, 2015 (JP) 2015-037782

(51) Int. Cl. B41J 2/14

(52) U.S. Cl. CPC B41J 2/14274

(57) ABSTRACT

The present invention is to provide an electronic device which is capable of suppressing deformation due to a restoring force of a bump electrode. The electronic device includes a pressure chamber forming substrate (29) which is provided with a piezoelectric element (32) causing a driving region (a1) to be deformed on the driving region (a1) capable of being bent and deformed, a sealing plate (33) which is disposed at intervals with respect to the pressure chamber forming substrate (29) in a state of interposing a bump electrode (40) having elasticity therebetween, and an adhesive (43) which bonds the pressure chamber forming substrate (29) and the sealing plate (33) in a state of maintaining the interval, and the adhesive (43) is provided on at least a region between the bump electrode (40) and the driving region (a1).

### TECHNICAL FIELD

The present invention relates to an electronic device on which a driving element causing a driving region to be deformed is provided.

### BACKGROUND ART

An electronic device is a device which includes a driving element such as a piezoelectric element performing deformation by applying a voltage, and is used for various apparatuses or sensors. For example, in a liquid ejecting apparatus, a liquid ejecting head using an electronic device ejects various liquid. As an example of such a liquid ejecting apparatus, there is an image recording apparatus such as an ink jet type printer or an ink jet type plotter, and recently, the liquid ejecting apparatus has been applied to various types of manufacturing apparatuses for the characteristic thereof that a very small amount of liquid can be landed accurately on a predetermined position. For example, the liquid ejecting apparatus has been applied to a display manufacturing apparatus which manufactures a color filter, such as one used in a liquid crystal display, an electrode forming apparatus which forms an electrode for an organic electro luminescence (EL) display, a field emission display (FED), or the like, and a chip manufacturing apparatus which manufactures a bio chip (biochemical element). A recording head of the image recording apparatus ejects a liquid type ink, and a color material ejecting head for the display manufacturing apparatus ejects a solution of each color material of red (R), green (G), and blue (B). In addition, an electrode material ejecting head for the electrode forming apparatus ejects a liquid type electrode material, and a biochemical organic substance ejecting head for the chip manufacturing apparatus ejects a bio organic substance solution.

The above described liquid ejecting head includes a pressure chamber forming substrate in which a pressure chamber penetrating nozzles is formed, a piezoelectric element (a type of driving element) which generates pressure fluctuation in the liquid inside the pressure chamber, and an electronic device in which a sealing plate, or the like which is disposed at intervals with respect to the piezoelectric element is laminated. Recently, a technology that provides a driving circuit (referred to as driver circuit) for driving the piezoelectric element on the sealing plate has been developed. Such a sealing plate and pressure chamber forming substrate on which the piezoelectric element is laminated are bonded to each other by an adhesive in a state of interposing a bump electrode therebetween (for example, refer to PTL 1). Accordingly, the driving circuit and the piezoelectric element are electrically connected to each other through the bump electrode.

### CITATION LIST

### Patent Literature

PTL 1: JP-A-2014-51008

### SUMMARY OF INVENTION

### Technical Problem

The bump electrode described above is provided on any one of the sealing plate and the pressure chamber forming substrate, and is conducted to an electrode which is provided on the other substrate by pressurization. Here, in order to reliably perform conduction by the bump electrode, the bump electrode having elasticity, in which the surface of a resin is covered with a conductive film, has been developed. Such a bump electrode is fixed between the sealing plate and the pressure chamber forming substrate in a state of being pressed in a height direction. However, there is a concern in that the sealing plate and the pressure chamber forming substrate is pressurized by a elastic restoring force of the pressed bump electrode, and the sealing plate or the pressure chamber forming substrate is deformed. Particularly, when the driving region (vibration region) driven by the piezoelectric element is deformed, there is a concern that liquid cannot be normally ejected.

The invention is made to solve the problems described above, and an object thereof is to provide the electronic device capable of suppressing deformation by restoring force of the bump electrode.

### Solution to Problem

An electronic device of the invention is proposed in order to achieve the object, and includes a first substrate that is provided with a driving element causing a driving region to be deformed on the driving region capable of being bent and deformed, a second substrate that is disposed at intervals with respect to the first substrate in a state of interposing a bump electrode having elasticity therebetween, and photosensitive adhesive that bonds the first substrate to the second substrate in a state of maintaining the intervals, in which the photosensitive adhesive is provided on at least a region between the bump electrode and the driving region.

According to this configuration, since the photosensitive adhesive is provided on a region between the bump electrode and the driving region, deformation of these substrates, particularly, deformation of the driving region can be suppressed by an elastic restoring force of the bump electrode even when stress is applied to between the first substrate and the second substrate. In addition, since the photosensitive adhesive is used for bonding the first substrate and the second substrate, the photosensitive adhesive can be accurately patterned by photolithography technology. Accordingly, the photosensitive adhesive can be brought as close as possible to other parts such as the driving region, which constitutes the electronic device, and the electronic device can be downsized. Further, since the adhesive is a photosensitive adhesive, without making an adhered surface widely wet, deterioration of the strength thereof which is generated because the width of the middle in a height direction becomes narrow (that is, constricted) can be suppressed.

In the configuration, it is preferable that the photosensitive adhesive is provided on both sides of the bump electrode.

According to this configuration, deformation of the first substrate and the second substrate can be further suppressed. In addition, the adhesive can be symmetrically disposed with respect to the bump electrode in both sides of the bump electrode. As a result, eccentric stress applied to the first substrate and the second substrate can be suppressed, and deformation of the first substrate and the second substrate can be further suppressed.

In the configuration, it is preferable that the photosensitive adhesive and the bump electrode are separately provided.

According to this configuration, at the time of conducting the first substrate with the second substrate by pressing the bump electrode, an interference of the elastic deformed bump electrode which is widened in a width direction due to the photosensitive adhesive can be suppressed. That is, a pressing margin of the bump electrode can be secured, therefore, conduction failure of the bump electrode can be suppressed.

In the configuration, it is preferable that the electronic device further includes a plurality of the bump electrodes in a first direction, and the photosensitive adhesive is provided in a row in the first direction.

According to this configuration, an attachment area of the photosensitive adhesive can be increased. Accordingly, attachment strength can be improved, and deformation of the first substrate and the second substrate can be further suppressed.

In the configuration, it is preferable that the electronic device further includes a plurality of the driving elements in the first direction, and the photosensitive adhesive is provided on the both sides of the bump electrode in the second direction orthogonal to the first direction.

According to this configuration, the size of the attachment area of the photosensitive adhesive can be further increased. Accordingly, the attachment strength can be improved, and deformation of the first substrate and the second substrate can be further reliably suppressed.

### BRIEF DESCRIPTION OF DRAWINGS

FIG. 1 is a perspective view illustrating a configuration of a printer.

FIG. 2 is a sectional view illustrating a configuration of a recording head.

FIG. 3 is a sectional view illustrating an enlarged main part of an electronic device.

FIG. 4 is a plan view illustrating a position relationship between an adhesive and a bump electrode.

FIG. 5A is a schematic view illustrating a manufacturing process of the electronic device.

FIG. 5B is a schematic view illustrating a manufacturing process of the electronic device.

### DESCRIPTION OF EMBODIMENTS

Hereinafter, embodiments for carrying out the invention will be described with reference to attached drawings. Also, in the embodiments described hereinafter, specific examples of the invention are variously and limitedly described; however, the scope of the present invention is not limited to these aspects unless otherwise stated scope which is particularly limited the invention in the following description. In addition, hereinafter, an ink jet type printer (hereinafter, printer) which is a type of the liquid ejecting apparatus, which includes an electronic device according to the invention and on which an ink jet type recording head (hereinafter, recording head) which is a type of a liquid ejecting head is mounted, will be described as an example.

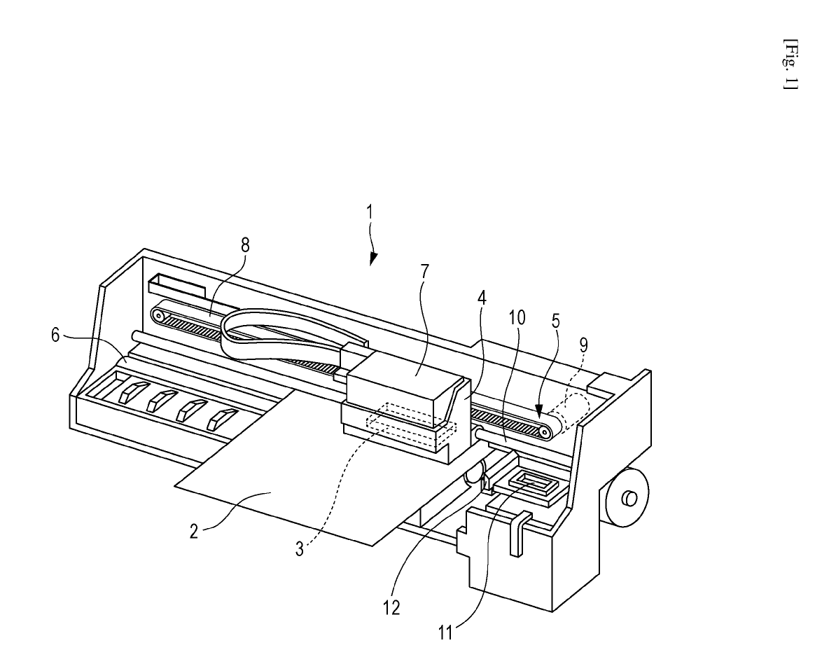

A configuration of a printer 1 will be described with reference to FIG. 1. The printer 1 is an apparatus which ejects ink (a type of liquid) onto a surface of a record medium 2 (a type of a landing target) such as a recording sheet, and records an image, or the like. The printer 1 includes a recording head 3, a carriage 4 in which the recording head 3 is mounted, a carriage moving mechanism 5 which moves the carriage 4 in a main scanning direction, and a transportation mechanism 6 which transports the record medium 2 in a sub scanning direction. Here, the ink described above is stored in an ink cartridge 7 as liquid supply source. The ink cartridge 7 is detachably mounted in the recording head 3. Moreover, the ink cartridge is disposed on a main body side of the printer, and the ink can be supplied from the ink cartridge to the recording head through an ink supplying tube.

The carriage moving mechanism 5 includes a timing belt 8. Also, the timing belt 8 is driven by a pulse motor 9 such as a DC motor. Accordingly, when the pulse motor 9 is operated, the carriage 4 is guided to a guide rod 10 which is provided in the printer 1, and reciprocates in a main scanning direction (width direction of record medium 2). A position of the main scanning direction of the carriage 4 is detected by a linear encoder (not illustrated), which is a type of position information detecting means. The linear encoder transmits a detected signal thereof, that is, an encoder pulse (a type of position information) to a controller of the printer 1.

In addition, in an end portion region outside a recording region within a moving range of the carriage 4, a home position which acts as a starting point of scanning of the carriage 4 is set. In the home position, from the end portion, a cap 11, which seals a nozzle 22 forming the nozzle surface (nozzle plate 21) of the recording head 3, and a wiping unit 12 for wiping the nozzle surface, are sequentially disposed.

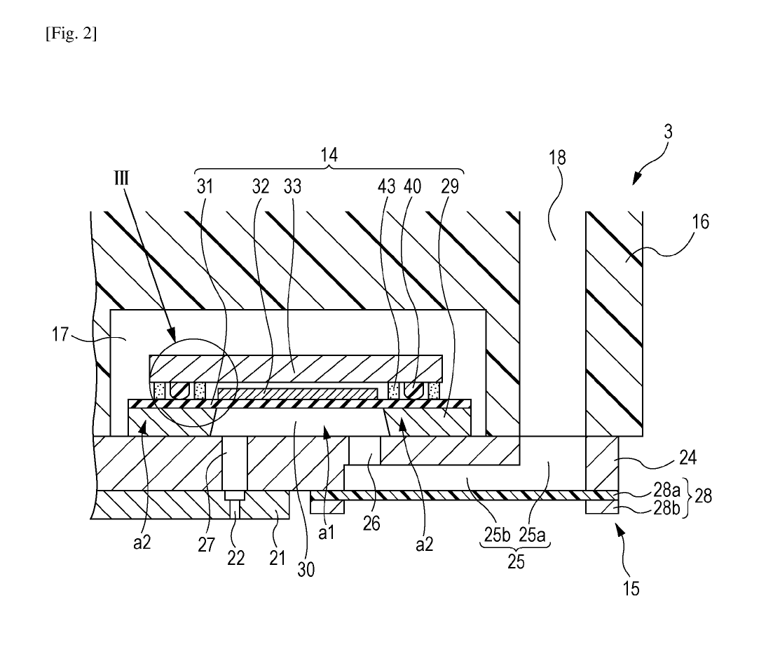

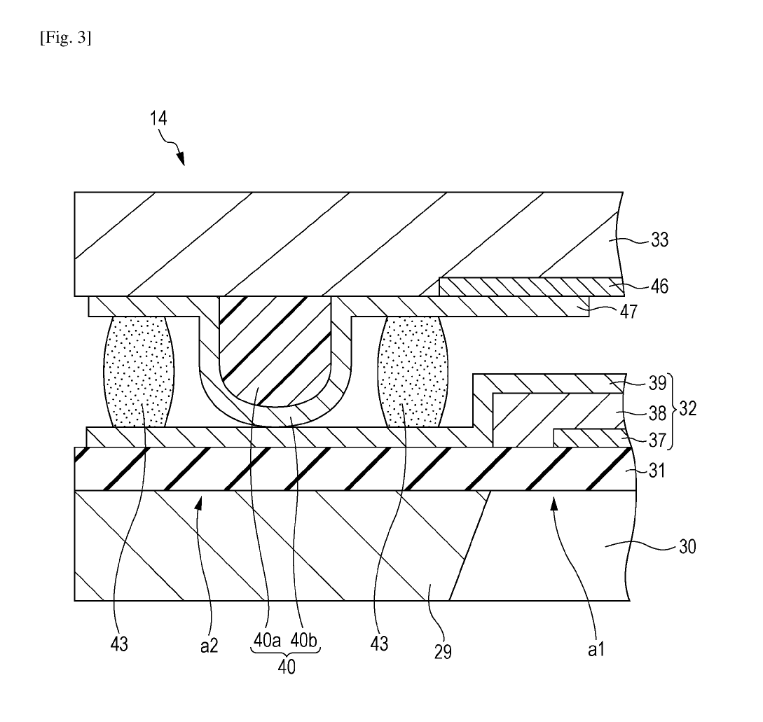

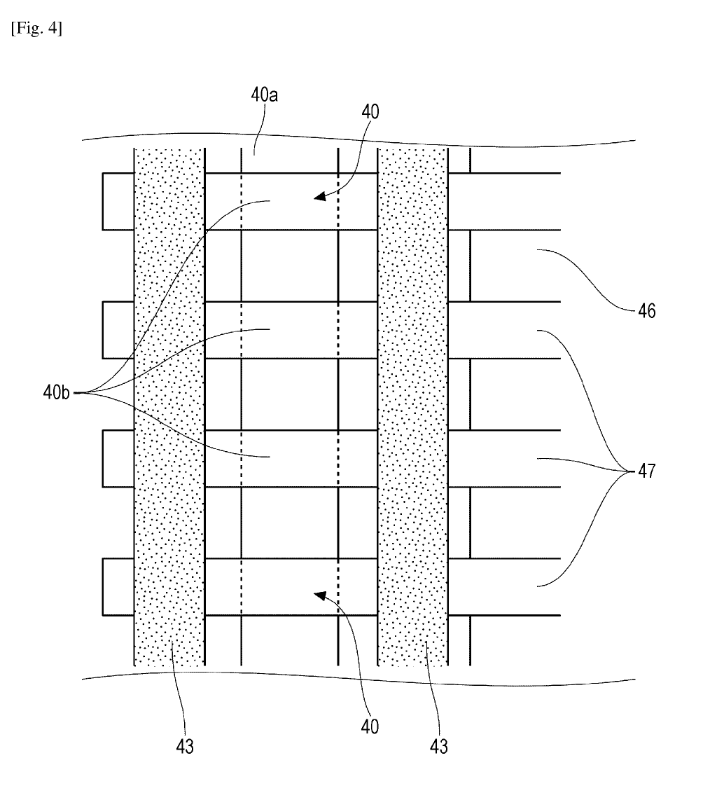

Next, the recording head 3 will be described. FIG. 2 is a sectional view illustrating a configuration of the recording head 3. FIG. 3 is an enlarged view of a region III in FIG. 2, and a sectional view of a main part of an electronic device 14 mounted in the recording head 3. FIG. 4 is a schematic view illustrating a position relationship between an adhesive 43 and a bump electrode 40, and a plan view of a sealing plate 33 bonded to a vibration plate 31 when seen from a bottom surface side (vibration plate 31 side). As illustrated in FIG. 2, the recording head 3 of the embodiment is mounted on a head case 16 in a state in which the electronic device 14 and a flow passage unit 15 are laminated. Moreover, for the sake of convenience, the direction in which each of members is laminated is referred to as a vertical direction.

A head case 16 is a box-shaped member made of synthetic resin, and is provided with a reservoir 18 therein which supplies the ink to each of pressure chambers 30. The reservoir 18 is a space where the ink common to the provided multiple pressure chambers 30 is stored, and is formed in a nozzle row direction. Also, an ink introduction passage (not illustrated) which introduces the ink from the ink cartridge 7 side to the reservoir 18 is formed on the head case 16. In addition, an accommodation space 17 is provided on the bottom surface side of the head case 16, and the accommodation space 17 is formed which is hollowed in a rectangular parallelepiped shape from the bottom surface to a middle of a height direction of the head case 16. When the flow passage unit 15 to be described later is bonded in a state of being positioned on the bottom surface of the head case 16, the electronic device 14 (pressure chamber forming substrate 29, sealing plate 33, or the like) laminated on a communication substrate 24 is accommodated in the accommodation space 17.

The flow passage unit 15 bonded on the bottom surface of the head case 16 includes the communication substrate 24, the nozzle plate 21, and a compliance sheet 28. The communication substrate 24 is a silicon plate material, and in the embodiment, is formed from a silicon single crystal substrate in which crystal plane orientation of the surfaces (top surface and bottom surface) are set to a (110) plane. In the communication substrate 24, as illustrated in FIG. 2, a common liquid chamber 25 which communicates the reservoir 18 and stores the ink common to each of pressure chambers 30, and an individual communication passage 26 which respectively supplies the ink from the reservoir 18 to each of the pressure chambers 30 through the common liquid chamber 25 are formed by etching. The common liquid chamber 25 is an empty part elongated in the nozzle row direction (perpendicular direction of pressure chamber 30). The common liquid chamber 25 is configured to have a first liquid chamber 25a penetrating a plate thickness direction of the communication substrate 24, and a second liquid chamber 25b which is hollowed from a bottom surface side of the communication substrate 24 toward a top surface side thereof to the middle of the plate thickness direction of the communication substrate 24, and is formed in a state in which a thin plate part is formed on the top surface side thereof. The individual communication passage 26 is a thin plate part of the second liquid chamber 25b. Multiple individual communication passages 26 are formed in the perpendicular direction of the pressure chamber 30 by corresponding to the pressure chambers 30. The individual communication passage 26 communicates an end portion of one side in the longitudinal direction of the corresponding pressure chamber 30 in a state of bonding the communication substrate 24 and the pressure chamber forming substrate 29 to each other.

In addition, a nozzle communication passage 27 penetrating in the plate thickness direction of the communication substrate 24 is formed on a position corresponding to each of the nozzles 22 of the communication substrate 24. That is, multiple nozzle communication passages 27 are formed in the nozzle row direction corresponding to the nozzle row. The pressure chamber 30 and the nozzle 22 communicate with each other by the nozzle communication passage 27. The nozzle communication passage 27 of the embodiment communicates an end portion of other side (opposite side of individual communication passage 26) in the longitudinal direction of the corresponding pressure chamber 30 in a state of bonding the communication substrate 24 and the pressure chamber forming substrate 29 to each other.

The nozzle plate 21 is a silicon substrate (for example, silicon single crystal substrate) bonded to the bottom surface (surface at an opposite side of pressure chamber forming substrate 29) of the communication substrate 24. The nozzle plate 21 of the embodiment is bonded in a region deviated from the compliance sheet 28 (common liquid chamber 25) in the communication substrate 24. In the nozzle plate 21, a plurality of the nozzles 22 are opened in a straight line shape (successive shape). The plurality of the nozzles 22 (nozzle row) provided in a row are provided at equal intervals in the sub scanning direction orthogonal to the main scanning direction at a pitch (for example, 600 dpi) corresponding to the dot formation density from the nozzle 22 on one end side to the nozzle 22 on the other end side.

The compliance sheet 28 is a region deviated from a region to which the nozzle plate 21 of the communication substrate 24 is bonded, and is bonded in a region corresponding to the common liquid chamber 25 in a state of blocking an opening of the bottom surface side of a space which is the common liquid chamber 25. The compliance sheet 28 is configured to have a flexible film 28a having flexibility and a hard fixing plate 28b fixed to a top surface of the flexible film 28a. In a position corresponding to the common liquid chamber 25 of the fixing plate 28b, an opening is provided so as not to interrupt flexible deformation of the flexible film 28a. Accordingly, a bottom surface of the common liquid chamber 25 becomes a compliance section which is divided by only the flexible film 28a. Pressure fluctuation generated in the ink inside the reservoir 18 and the common liquid chamber 25 can be absorbed by a compliance section.

The electronic device 14 of the embodiment is a thin film shaped device which functions as an actuator causing the pressure fluctuation to generate in the ink inside each of the pressure chambers 30. As illustrated in FIG. 2, the electronic device 14 is formed as a unit by laminating the pressure chamber forming substrate 29, the vibration plate 31, a piezoelectric element 32, and the sealing plate 33 as illustrated in FIG. 2. Moreover, the electronic device 14 is formed to be smaller size than the accommodation space 17 so as to be capable of being accommodated in the accommodation space 17.

The pressure chamber forming substrate 29 is a hard silicon plate material, and in the embodiment, is produced using a silicon single crystal substrate in which the crystal plane orientation of the surfaces (top surface and bottom surface) are set to as the (110) plane. In the pressure chamber forming substrate 29, a part thereof is completely removed by etching in the plate thickness direction, and a space to be the pressure chamber 30 is formed. This space, that is, multiple pressure chambers 30 are juxtaposed in the nozzle row direction (corresponding to first direction in the invention) by corresponding to each of the nozzles 22. Each of the pressure chambers 30 is an empty part elongated in a direction (corresponding to second direction in the invention) orthogonal to the nozzle row direction. An end portion of one side of the longitudinal direction communicates the individual communication passage 26, and an end portion of the other side thereof communicates the nozzle communication passage 27.

The vibration plate 31 is a thin film type member having elasticity, and is laminated on a top surface (surface opposite communication substrate 24) of the pressure chamber forming substrate 29. An upper opening of a space to be the pressure chamber 30 is sealed with the vibration plate 31. In other words, the pressure chamber 30 is divided by the vibration plate 31. A part corresponding to the pressure chamber 30 in the vibration plate 31 (for details, upper opening of pressure chamber 30) functions as a displacement portion which is displaced in a direction away from or close to the nozzle 22 in accordance with bending and deforming of the piezoelectric element 32. That is, a region corresponding to the upper opening of the pressure chamber 30 in the vibration plate 31 becomes a driving region a1 which is capable of being bent and deformed. Meanwhile, a region deviated from the upper opening of the pressure chamber 30 in the vibration plate 31 becomes a non-driving region a2 which is not easily bent and deformed.

In addition, for example, the vibration plate 31 is formed of an elastic film made of a silicon dioxide (SiO₂) formed on a top surface of the pressure chamber forming substrate 29, and an insulation film made of a zirconium oxide (ZrO₂) formed on the elastic film. Also, the piezoelectric elements 32 are respectively laminated on a region corresponding to each of the pressure chambers 30 in the insulation film (surface opposite pressure chamber forming substrate 29 side of vibration plate 31), that is, on the driving region a1. Each of the piezoelectric elements 32 is formed in the nozzle row direction by corresponding to the pressure chambers 30 juxtaposed in the nozzle row direction (first direction). Moreover, the pressure chamber forming substrate 29 and the vibration plate 31 laminated thereon correspond to a first substrate in the invention.

The piezoelectric element 32 of the embodiment is a so called bending mode piezoelectric element. As illustrated in FIG. 3, for example, the piezoelectric element 32 is configured to have a lower electrode layer 37 (individual electrode), a piezoelectric layer 38, and a upper electrode layer 39 (common electrode), which are sequentially laminated on the vibration plate 31. Such a piezoelectric element 32 is bent and deformed in a direction away from or close to the nozzle 22, when an electronic field corresponding to the potential difference between both electrodes is applied between the lower electrode layer 37 and the upper electrode layer 39. As illustrated in FIG. 3, an end portion of the other side (left side in FIG. 2 and FIG. 3) of the upper electrode layer 39 extends from the driving region a1 to the non-driving region a2 over a region on which the piezoelectric layer 38 is laminated. Although it is not illustrated, the end portion of one side of the lower electrode layer 37 (right side in FIG. 2 and FIG. 3) extends from the driving region a1 over a region on which the piezoelectric layer 38 is laminated, to the non-driving region a2 which is an opposite side of the non-driving region a2 on which the upper electrode layer 39 is laminated. That is, in the longitudinal direction of the pressure chamber 30, the lower electrode layer 37 extends to one side of the non-driving region a2, the upper electrode layer 39 extends to the other side of the non-driving region a2. Also, bump electrodes 40 (to be described later) are respectively bonded to the extended lower electrode layer 37 and upper electrode layer 39.

The sealing plate 33 (corresponding to second substrate in the invention) is a silicon substrate in a flat plate shape disposed with intervals with respect to the vibration plate 31 (or the piezoelectric element 32). In the embodiment, the sealing plate 33 is made of the silicon single crystal substrate having the crystal plane orientation of the surfaces (top surface and bottom surface) as the (110) plane. As illustrated in FIG. 3, a driving circuit 46 (driver circuit) for respectively driving each of the piezoelectric elements 32 is formed on a region facing the piezoelectric element 32 of the sealing plate 33. The driving circuit 46 is formed by performing a semiconductor process (that is, film forming process, photolithography process, etching process, or the like) on a surface of the silicon single crystal substrate (silicon wafer) which becomes the sealing plate 33. In addition, a wiring layer 47 connected to the driving circuit 46 is formed on the driving circuit 46 in a surface of the piezoelectric element 32 side of the sealing plate 33 in a state of being exposed on a surface of the sealing plate 33. The wiring layer 47 is laid to a position outside further than the driving circuit 46 and facing the lower electrode layer 37 and the upper electrode layer 39 which are laminated on the non-driving region a2. Also, a part thereof is formed on internal resin 40a as the conductive film 40b of the bump electrode 40 (to be described later). In addition, the wiring layer 47 is integrally illustrated in FIG. 3 for the sake of convenience; however, it includes a plurality of wires. Each of the wires included in the wiring layer 47 is electrically connected to a corresponding wire inside the driving circuit 46. In addition, as the wiring layer 47, a metal such as gold (Au), copper (Cu), nickel (Ni), or the like is used.

The pressure chamber forming substrate 29 on which the vibration plate 31 and the piezoelectric element 32 are laminated, and the sealing plate 33 are bonded to each other in a state of interposing the bump electrode 40 therebetween by the photosensitive adhesive 43 (corresponding to photosensitive adhesive in the invention). That is, the adhesive 43 makes the pressure chamber forming substrate 29 and the sealing plate 33 bond to each other in a state in which intervals between the pressure chamber forming substrate 29 and the sealing plate 33 are maintained. Specifically, as illustrated in FIG. 2, the intervals between the vibration plate 31 and the sealing plate 33 are maintained by the bump electrode 40 and the adhesive 43 formed on the non-driving region a2 of both sides in the longitudinal direction of the pressure chamber 30 with the piezoelectric element 32 therebetween. Also, the intervals are set so as not to inhibit the deformation of the piezoelectric element 32, and for example, are set to approximately 5 μm to 25 μm.

The bump electrode 40 of the embodiment has elasticity, and protrudes from a surface of the sealing plate 33 toward the pressure chamber forming substrate 29 side. Specifically, as illustrated in FIG. 3 and FIG. 4, the bump electrode 40 includes the internal resin 40a having elasticity and the conductive film 40b which is made of the wiring layer 47 and covers a surface of the internal resin 40a. The internal resin 40a of the embodiment forms on protrusions, in a region facing the non-driving region a2 on which the lower electrode layer 37 is formed, and in a region facing the non-driving region a2 on which the upper electrode layer 39 is formed in a surface of the sealing plate 33 in the nozzle row direction (first direction), respectively. In addition, multiple conductive films 40b facing the lower electrode layer 37 (individual electrode) are formed in the nozzle row direction by corresponding to the piezoelectric elements 32 formed in a row in the nozzle row direction. In the same manner, the multiple conductive films 40b facing the upper electrode layer 39 (common electrode) are formed in the nozzle row direction. That is, multiple bump electrodes 40 are respectively formed in the nozzle row direction (first direction). Also, as the internal resin 40a, for example, resin such as polyimide resin is used.

Here, as illustrated in FIG. 3 and FIG. 4, the adhesive 43 is formed on both sides of the bump electrode 40 in a direction (second direction) orthogonal to the nozzle row direction (first direction) in a state of being separated from the bump electrode 40. Specifically, the adhesive 43 is formed on the non-driving region a2 between the bump electrode 40 and the driving region a1 (or piezoelectric layer 38), and on the non-driving region a2 opposite the driving region a1 side with respect to the bump electrode 40. The adhesive 43 is formed in a belt type in the nozzle row direction (first direction). Moreover, the adhesive 43 of the embodiment, a width (size of second direction) of a surface of the vibration plate 31 (for details, a surface of the lower electrode layer 37 or the upper electrode layer 39) and a surface of the sealing plate 33 (for details, a surface of the wiring layer 47) is greater than a width between the vibration plate 31 and the sealing plate 33. That is, the adhesive 43 is formed in a shape in which an intermediate part between the vibration plate 31 and the sealing plate 33 expands toward the outside. In addition, the adhesive 43 is symmetrically disposed in both sides of the bump electrode 40 with respect to the bump electrode 40.

Hereinabove, the bump electrode 40 and the adhesive 43 illustrated in FIG. 3, that is, the bump electrode 40 and the adhesive 43 which are disposed on the other side (left side in FIG. 2) are mainly described; however, the bump electrode 40 and the adhesive 43 which are disposed on one side (right side in FIG. 2) are also formed in the same manner. In addition, as the adhesive 43, an adhesive having photosensitivity and thermosetting properties is used. For example, a resin mainly including an epoxy resin, an acrylic resin, a phenol resin, a polyimide resin, a silicone resin, a styrene resin, or the like is preferably used.

The recording head 3 which is formed as described above guides the ink from the ink cartridge 7 to the pressure chamber 30 through an ink introduction passage, the reservoir 18, the common liquid chamber 25, and the individual communication passage 26. In a state described above, when a driving signal from the driving circuit 46 is applied to the piezoelectric element 32 through the bump electrode 40, the pressure fluctuation is generated in the pressure chamber 30 by driving the piezoelectric element 32. The recording head 3 ejects the ink droplets from the nozzle 22 through the nozzle communication passage 27 using the pressure fluctuation.

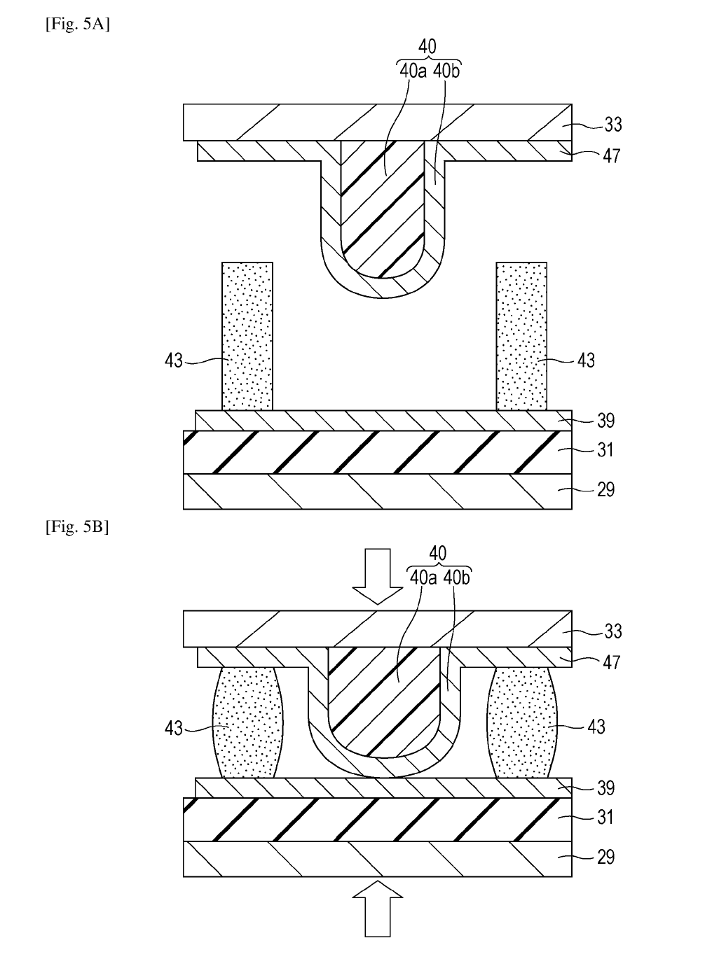

Next, a manufacturing method of the recording head 3 described above will be described, and particularly, a manufacturing method of the electronic device 14 will be described. FIGS. 5A and 5B are perspective views illustrating a manufacturing process of the electronic device 14. After bonding the silicon single crystal substrate (silicon wafer), on which multiple regions which become the sealing plate 33 are formed, to the silicon single crystal substrate (silicon wafer), on which multiple regions which becomes the pressure chamber forming substrate 29 are formed, (here, the vibration plate 31 and the piezoelectric element 32 are laminated on the pressure chamber forming substrate 29), the resultant is cut into individual pieces, and thus the electronic device 14 of the embodiment is obtained.

When described in detail, first, the driving circuit 46 is formed on a surface (surface opposite pressure chamber forming substrate 29 side) in the silicon single crystal substrate of the sealing plate 33 side by a semiconductor process. Next, a resin film is formed on the surface, the internal resin 40a is formed through the photolithography process and an etching process, and then the internal resin 40a is heated and thus melted, thereby rounding the angles thereof. Subsequently, a metal film is formed on the surface by evaporating, sputtering, or the like, and the wiring layer 47 (conductive film 40b) is formed by a photolithography process and an etching process. Accordingly, multiple regions corresponding to each of the recording heads 3 which become the sealing plate 33 are formed on the silicon single crystal substrate. Meanwhile, the silicon single crystal substrate of the pressure chamber forming substrate 29 side, first, the vibration plate 31 is laminated on a surface (surface of a side facing sealing plate 33 side). Next, the lower electrode layer 37, the piezoelectric layer 38, the upper electrode layer 39, and the like are sequentially patterned by the semiconductor process, and the piezoelectric element 32 is formed. Accordingly, multiple regions which become the pressure chamber forming substrate 29 corresponding to each of the recording heads 3 are formed on the silicon single crystal substrate.

When the sealing plate 33 and the pressure chamber forming substrate 29 are formed on each of the silicon single crystal substrates, an adhesive layer is formed on a surface of the silicon single crystal substrate of the pressure chamber forming substrate 29 side, and the adhesive 43 is formed on a predetermined position by the photolithography process. Specifically, a liquid type adhesive having photosensitivity and thermosetting properties is applied onto the vibration plate 31 by a spin coater, and the adhesive layer having elasticity is formed by heating. Also, by exposing and developing, the shape of the adhesive 43 is patterned at a predetermined position (refer to FIG. 5A). Here, the adhesive 43 is formed to be separated from the bump electrode 40 in order to ensure pressing margin of the bump electrode 40. The intervals between the bump electrode 40 and the adhesive 43 are set to a size of a degree in which both do not interfere with each other even when the sealing plate 33 and the pressure chamber forming substrate 29 are pressurized, and the bump electrode 40 and the adhesive 43 are pressed.

In addition, when the adhesive 43 is formed, both silicon single crystal substrates are bonded to each other. Specifically, any one of the silicon single crystal substrate is relatively moved toward the other of the silicon single crystal substrate side, and these are bonded to each other with the adhesive 43 interposed between both silicon single crystal substrates. In this state, the both silicon single crystal substrates are pressurized in a vertical direction by resisting a restoring force of the bump electrode 40 (refer to arrow in FIG. 5B). Accordingly, as illustrated in FIG. 5B, the bump electrode 40 is pressed, and can reliably communicate the lower electrode layer 37, the upper electrode layer 39, and the like of the pressure chamber forming substrate 29 side. Also, the substrates are heated to a curing temperature of the adhesive 43 while being pressurized. As a result, the adhesive 43 is cured, and the both silicon single crystal substrates are bonded to each other in a state in which the bump electrode 40 is pressed. The adhesive 43 at this time is cured in a state in which the center portion in a height direction thereof expands toward the outside.

When the both silicon single crystal substrates are bonded to each other, the silicon single crystal substrate of the pressure chamber forming substrate 29 side is grounded from a rear surface side (opposite side of silicon single crystal substrate of sealing plate 33 side), and the silicon single crystal substrate of the pressure chamber forming substrate 29 side is made thin. After that, the pressure chamber 30 is formed on the thinned silicon single crystal substrate of the pressure chamber forming substrate 29 side by the photolithography process and the etching process. Finally, scribing is performed on a predetermined scribe line, and the resultant is cut into each of the electronic devices 14. Meanwhile, in the above-described method, the electronic device 14 is produced by bonding two silicon single-crystal substrates and then compartmentalizing the bonded substrates, but the method for producing the electronic device is not limited thereto. For example, it is also possible to respectively compartmentalize the sealing plate and the pressure chamber forming substrate in advance and then bond the sealing plate and the pressure chamber forming substrate. Even in this case, bonding of the sealing plate and the pressure chamber forming substrate to each other through the bump electrode is performed in the same manner.

Also, the electronic device 14 formed by the processes described above is fixed to the flow passage unit 15 (communication substrate 24) using the adhesive, or the like. In addition, in a state in which the electronic device 14 is accommodated in the accommodation space 17 of the head case 16, the recording head 3 is formed by bonding the head case 16 to the flow passage unit 15.

As described above, in the embodiment, since the adhesive 43 is provided on a region between the bump electrode 40 and the driving region a1, deformation of the sealing plate 33 and the pressure chamber forming substrate 29 due to an elastic restoring force of the bump electrode 40, particularly, deformation of the driving region a1 can be suppressed even when stress is applied between the sealing plate 33 and the pressure chamber forming substrate 29. In addition, since the adhesive 43 having photosensitivity is used for bonding the sealing plate 33 and the pressure chamber forming substrate 29, the adhesive 43 can be accurately patterned using a photolithography technology. Accordingly, the adhesive 43 can be brought as close as possible to other parts such as the driving region a1, which constitutes the electronic device 14, and the electronic device 14 can be downsized. Further, since the adhesive 43 has photosensitivity, without making an adhered surface widely wet, deterioration of strength thereof which is generated because a width of a middle of a height direction becomes narrow (that is, constricted) can be suppressed.

In addition, in the embodiment, the adhesive 43 is provided between both sides of the bump electrode 40, and thus deformation of the sealing plate 33 and the pressure chamber forming substrate 29 can be further suppressed. Further, the adhesive 43 can be symmetrically provided with respect to the bump electrode 40 in both sides of the bump electrode 40. As a result, eccentric stress applied to the sealing plate 33 and the pressure chamber forming substrate 29 can be suppressed, and deformation of the sealing plate 33 and the pressure chamber forming substrate 29 can be further suppressed. In addition, the adhesive 43 is provided in a row in the nozzle row direction, and the attachment area of the adhesive 43 can be increased. Accordingly, the attachment strength can be improved, and deformation of the sealing plate 33 and the pressure chamber forming substrate 29 can be further suppressed. Further, when the adhesive 43 is provided in a row on the both sides of the bump electrode 40 in a direction orthogonal to the nozzle row direction, the attachment area of the adhesive 43 can be further increased. Accordingly, the attachment strength can be improved, and deformation of the sealing plate 33 and the pressure chamber forming substrate 29 can be reliably suppressed. In addition, the adhesive 43 is provided to be separated from the bump electrode 40, at the time of conducting the sealing plate 33 with the pressure chamber forming substrate 29, and an interference of the elastic deformed bump electrode 40 by the adhesive 43 so as to be widely pressed in a width direction can be suppressed. That is, the pressing margin of the bump electrode 40 can be secured, therefore, conduction failure of the bump electrode 40 can be suppressed.

In the embodiment described above, the bump electrode 40 is provided on the sealing plate 33 side; however, it is not limited thereto. For example, the bump electrode can be provided on a pressure chamber substrate side. In addition, in the manufacturing method described above, the adhesive 43 is applied to the silicon single crystal substrate of the pressure chamber forming substrate 29 side; however, it is not limited thereto. For example, the adhesive can also be applied to the silicon single crystal substrate of the sealing plate side. In addition, the adhesive can be applied to both of the silicon single crystal substrate of the pressure chamber forming substrate side and the silicon single crystal substrate of the sealing plate side. Further, in the embodiment described above, the bump electrode 40 is configured to have the internal resin 40a and the conductive film 40b; it is not limited thereto. In short, any bump electrode having elasticity may be used.

In addition, in the embodiment described above, the adhesive 43 is symmetrically provided with respect to the bump electrode 40; however, it is not limited thereto. The adhesive may be formed so that any one side of internal or external attachment areas is formed greater than the other side of the attachment area with respect to the bump electrode. For example, relatively, when an amount of the adhesive disposed on a region outside the bump electrode having an extra space is increased, and the attachment area is increased, deformation of the sealing plate 33 and the pressure chamber forming substrate 29 can be further suppressed.

Further, in the embodiment described above, the driving circuit 46 is formed on the sealing plate 33; however, it is not limited thereto. Any configuration may be used as long as a layer which becomes an electrode is formed on the sealing plate, and the electrode conducts the electrode of the pressure chamber forming substrate side by the bump electrode. For example, a substrate on which the driving circuit is formed is bonded onto the sealing plate, and only a wire may be provided on the sealing plate. In this case, the driving circuit formed on a substrate different from the sealing plate is electrically connected to the piezoelectric element through the wire formed on the sealing plate and the bump electrode.

Hitherto, as the liquid ejecting head, the ink jet type recording head mounted in the ink jet type printer is exemplified; however, a liquid ejecting head can be also used for a printer which ejects liquid other than the ink. For example, the invention can also be applied to a color material ejecting head which is used for manufacturing a color filter of a liquid crystal display, or the like, an electrode material ejecting head used for forming an electrode of an organic electro luminescence (EL) display, a field emission display (FED), or the like, and a biochemical organic substance ejecting head used for manufacturing a biochip (biochemical substance element), or the like.

In addition, the invention is not limited to being used for the liquid ejecting head as an actuator, and for example, can be applied for an electronic device, or the like used in various sensors, or the like.

### REFERENCE SIGNS LIST

1 Printer
3 Recording head
14 Electronic device
15 Flow passage unit
16 Head case
17 Accommodation space
18 Reservoir
21 Nozzle plate
22 Nozzle
24 Communication substrate
25 Common liquid chamber
26 Individual communication passage
28 Compliance sheet
29 Pressure chamber forming substrate
30 Pressure chamber
31 Vibration plate
32 Piezoelectric element
33 Sealing plate
37 Lower electrode layer
38 Piezoelectric layer
39 Upper electrode layer
40 Bump electrode
43 Adhesive
46 Driving circuit
47 Wiring layer

1. An electronic device comprising:
a first substrate that is provided with a driving element causing a driving region to be deformed on the driving region capable of being bent and deformed;
a second substrate that is disposed at intervals with respect to the first substrate in a state of interposing a bump electrode having elasticity therebetween; and
photosensitive adhesive that bonds the first substrate to the second substrate in a state of maintaining the interval,
wherein the photosensitive adhesive is provided on at least a region between the bump electrode and the driving region.

2. The electronic device according to claim 1, wherein the photosensitive adhesive is provided on both sides of the bump electrode.

3. The electronic device according to claim 1, wherein the photosensitive adhesive and the bump electrode are separately provided.

4. The electronic device according to any one of claim 1, further comprising:
a plurality of the bump electrodes in a first direction, wherein the photosensitive adhesive is provided in a row in the first direction.

5. The electronic device according to claim 4, further comprising:
a plurality of the driving elements in the first direction,
wherein the photosensitive adhesive is provided on the both sides of the bump electrode in the second direction orthogonal to the first direction.
